(19) United States
(12) Patent Application Publication
(10) Pub. No.: US 2025/0134069 A1
(43) Pub. Date: May 1, 2025

(54) A HORN GROWTH STUNTING DEVICE AND A METHOD FOR STUNTING THE GROWTH OF A HORN OF AN ANIMAL

(71) Applicant: OGLESBY & BUTLER RESEARCH & DEVELOPMENT LIMITED, Carlow (IE)

(72) Inventors: John Joseph STOREY, Portlaoise (IE); Michael Aidan DOOLEY, Castledermot (IE); John Barry Townsend, Carlow (IE)

(73) Assignee: OGLESBY & BUTLER RESEARCH & DEVELOPMENT LIMITED, Carlow (IE)

(21) Appl. No.: 18/835,453

(22) PCT Filed: Feb. 2, 2023
(86) PCT No.: PCT/IE2023/000003

§ 371 Date: Aug. 2, 2024

(30) Foreign Application Priority Data
Feb. 3, 2022 (IE) S2022/0020

(51) Int. Cl. A01K 17/00

(52) U.S. Cl. CPC A01K 17/00

(57) ABSTRACT

A horn growth stunting device (1) comprises a handle (3) within which fuel gas is located in a reservoir having a cylindrical main housing (10) extending from the handle (3). A gas catalytic element (32) is located in a combustion chamber (39) defined by a tubular sub-housing (40) located concentrically in the main housing (10) for converting fuel gas to heat. A hot gas stream generated by the gas catalytic element (32) is directed through a nozzle (55) defined by a distal end (43) of the tubular sub-housing (40) to an open mouth (29) defined by a distal horn bud engaging rim (28) adjacent a distal end (17) of the main housing (10). A periphery (96) of the horn bud (95) is engaged by the horn bud engaging rim (28) of the main housing (10) with a central portion (97) of the horn bud (95) extending into the main housing (10), so that the hot gas stream is delivered to the horn bud (95) through the nozzle (55) for cauterising the horn bud (95). Gases from the hot gas stream deflected by the horn bud (95) are exhausted through an annular exhaust gas passageway (62) defined between the tubular housing (40) and the main housing (10) and in turn through exhaust gas ports (64) extending through the main housing (10).

The present invention relates to a horn growth stunting device, and the invention also relates to a method for stunting the growth of a horn bud of an animal.

Devices for stunting the growth of a horn of an animal are known. Such devices, typically comprise a device which either applies a flame to the bud of a horn, typically, in a young animal, such as a calf which singes the bud, thereby stunting, and in turn preventing further growth of the horn. Another type of horn stunting device is disclosed in PCT Patent Specification No. WO 1993/012377 of Oglesby, which discloses a gas-powered heating device, in which a metal tool bit terminating in a concave end is heated by a gas catalytic element. The concave end of the tool bit substantially defines the tip of a horn bud of an animal, and by applying the heated concave end of the tool bit to the bud of the horn of the animal, the horn bud is singed, thereby stunting and thus preventing growth of the horn.

While the horn stunting device disclosed in PCT Specification No. WO 1993/012377 is adequate for stunting and thus preventing growth of a horn of an animal, an improved more humane horn growth stunting device would be desirable.

The present invention is directed towards providing such a horn growth stunting device, and the invention is also directed towards providing a method for stunting the growth of a horn bud of an animal.

According to the invention there is provided a horn growth stunting device comprising a main housing defining a main chamber and terminating in a horn bud engaging distal rim defining an open mouth to the main chamber, a gas catalytic element for converting fuel gas to heat and being configured to generate a hot gas stream, a means configured to direct the hot gas stream from the gas catalytic element into the main chamber and towards the open mouth thereof, so that when the horn bud engaging distal rim of the main housing is engaged with a horn bud of an animal, the hot gas stream is directed onto a portion of the horn bud in the open mouth.

In one embodiment of the invention the means to direct the hot gas stream towards the open mouth of the main chamber comprises a nozzle communicating with the gas catalytic element for diverting the hot gas stream to the open mouth of the main chamber. Preferably, the nozzle terminates in a distal nozzle outlet adapted to direct the hot gas stream to the open mouth of the main chamber.

In one embodiment of the invention the main chamber extends from a proximal end to a distal end terminating in the horn bud engaging distal rim defining the open mouth to the main chamber.

In another embodiment of the invention the nozzle extends into the main chamber with the nozzle outlet directed towards and spaced apart proximally from the open mouth defined by the horn bud engaging distal rim.

In one embodiment of the invention the nozzle outlet is spaced apart proximally from the open mouth defined by the horn bud engaging distal rim a distance in the range of 5 mm to 40 mm, and preferably, in the range of 10 mm to 20 mm, and ideally, the nozzle outlet is spaced apart from the open mouth defined by the horn bud engaging distal rim a distance of approximately 15 mm.

In one embodiment of the invention an exhaust gas passageway extends in a proximal direction from the main chamber for accommodating exhaust gases from the main chamber deflected from the horn bud to at least one exhaust port.

In one embodiment of the invention at least a portion of the exhaust gas passageway is defined between the nozzle and a portion of the main housing defining the main chamber.

Preferably, the exhaust gas passageway comprises an annular exhaust gas passageway, and preferably, the exhaust gas passageway extends around the nozzle.

In another embodiment of the invention the gas catalytic element is located in the main housing, and preferably, is located in a combustion chamber located in the main housing proximal of the main chamber.

In another embodiment of the invention the gas catalytic element comprises an elongated element extending from a proximal end to a distal end.

In another embodiment of the invention the nozzle communicates with the distal end of the gas catalytic element.

In one embodiment of the invention the combustion chamber is located in a sub-housing, and preferably, the sub-housing is located in the main chamber. Preferably, the sub-housing comprises an elongated tubular housing, which advantageously, is open at its respective opposite ends.

In one embodiment of the invention the sub-housing defines with a portion of the main housing, the exhaust gas passageway.

In one embodiment of the invention the sub-housing defines with the portion of the main housing the exhaust gas passageway as an annular exhaust gas passageway, and preferably, the exhaust gas passageway defined between the sub-housing and the main housing defining the combustion chamber extends around the sub-housing.

Preferably, the exhaust gas passageway defined between the sub-housing and the main housing terminates in the at least one exhaust gas port, extending through the main housing, and advantageously, a plurality of exhaust gas ports are located at circumferentially spaced apart intervals around and extending through the main housing.

In another embodiment of the invention a flame combustion chamber is located in the main housing for accommodating flame combustion of fuel gas therein for raising the temperature of the gas catalytic element to its ignition temperature.

In one embodiment of the invention the flame combustion chamber is located between the gas catalytic element and the horn bud engaging distal rim of the main chamber, and preferably, the main chamber communicates with the gas catalytic element through the flame combustion chamber.

In another embodiment of the invention an electrode extends into the flame combustion chamber for igniting fuel gas to burn in a flame therein.

Preferably, the nozzle communicates with the gas catalytic element through the flame combustion chamber.

In another embodiment of the invention a delivery means is provided for delivering fuel gas to the gas catalytic element, and advantageously, the delivery means is configured for delivering the fuel gas to the gas catalytic element adjacent the proximal end thereof.

Preferably, the delivery means is located proximal of the gas catalytic element.

In another embodiment of the invention the delivery means is located in the main housing.

Preferably, the delivery means comprises a Venturi mixer for mixing air with the fuel gas for delivery to the gas catalytic element.

In another embodiment of the invention the gas catalytic element is configured to produce the hot gas stream at a working temperature in the range of 300° C. to 600° C., and preferably, in the range of 350° C. to 550° C., and advantageously, the gas catalytic element is configured to convert fuel gas to heat at a working temperature of approximately 450° C. to 500° C.

In one embodiment of the invention the gas catalytic element is configured to produce the hot gas stream at the working temperature within a time period from ignition thereof in the range of 30 seconds to 120 seconds, and preferably, in the range of 45 seconds to 90 seconds, and advantageously, within a time period of approximately 60 seconds.

In another embodiment of the invention a handle is provided extending from the main housing, and advantageously, the handle defines a fuel gas reservoir for storing fuel gas in liquid form for supply to the delivery means.

Preferably, the horn growth stunting device is configured as a portable device, and advantageously, is configured as a hand-held portable device.

In one embodiment of the invention the main housing comprises a tubular housing, and preferably, the main housing defines a longitudinally extending main central axis.

In one embodiment of the invention the main chamber is concentric with the main central axis defined by the main housing, and advantageously, the nozzle is concentric with the main central axis.

In another embodiment of the invention the gas catalytic element is concentric with the main central axis defined by the main housing, and advantageously, the sub-housing is concentric with the main central axis. Preferably, the sub-housing is of circular transverse cross-section.

In another embodiment of the invention the handle comprises a tubular handle, and advantageously, the handle defines a central handle axis, which preferably, coincides with the main central axis defined by the main housing.

In one embodiment of the invention the main housing is of circular transverse cross-section, and preferably, the handle is of circular transverse cross-section.

In one embodiment of the invention the horn growth stunting device is adapted for stunting growth of a horn bud of a calf.

The invention also provides a method for stunting the growth of a horn bud of an animal, the method comprising directing a hot gas stream through a nozzle from a gas catalytic element to a horn bud of the animal, the growth of which is to be stunted, to impinge on the horn bud.

In one embodiment of the invention a nozzle outlet of the nozzle is spaced apart in use from the horn bud. Preferably, the nozzle outlet of the nozzle is spaced apart in use from the horn bud a distance in the range of 3 mm to 40 mm. Advantageously, the nozzle outlet of the nozzle is spaced apart in use from the horn bud a distance in the range of 3 mm to 15 mm. More preferably, the nozzle outlet of the nozzle is spaced apart in use from the horn bud a distance in the range of 3 mm to 10 mm. Ideally, the nozzle outlet of the nozzle is spaced apart in use from the horn bud a distance in the range of 3 mm to 7 mm.

In one embodiment of the invention the nozzle outlet of the nozzle is spaced apart in use from the horn bud a distance of approximately 5 mm.

In another embodiment of the invention the gas catalytic element produces the hot gas stream at a working temperature in the range of 300° C. to 600° C., and preferably, at a working temperature in the range of 350° C. to 550° C., and advantageously, at a working temperature in the range of 450° C. to 500° C., and ideally, at a working temperature of approximately 450° C.

The invention also provides a method for stunting the growth of a horn bud of an animal comprising directing a hot gas stream at the horn bud, the hot gas stream being derived from a horn growth stunting device according to the invention.

In one embodiment of the invention the horn bud engaging distal rim of the main housing of the horn growth stunting device is engaged with the horn bud adjacent an outer periphery thereof, with a substantially central portion of the horn bud located in the open mouth to the main chamber. Preferably, the hot gases are directed to the horn bud from the nozzle to impinge thereon.

In one embodiment of the invention the method is carried out using the horn growth stunting device according to the invention, and in one embodiment of the invention the horn bud engaging distal rim of the main housing is engaged with the horn bud adjacent an outer periphery thereof, with a substantially central portion of the horn bud located in the open mouth to the main chamber, and preferably, the hot gases are directed to the horn bud from the nozzle to impinge thereon.

Preferably, the nozzle outlet of the nozzle is spaced apart in use from the horn bud, and in one embodiment of the invention the nozzle outlet of the nozzle is spaced apart in use from the horn bud a distance in the range of 3 mm to 35 mm, and preferably, in the range of 3 mm to 15 mm, and advantageously, a distance in the range of 3 mm to 10 mm.

The advantages of the invention are many. A particularly important advantage of the invention is that by virtue of the fact that the horn bud is cauterised by the hot gas stream, the horn bud is not burnt, nor is it singed, the hot gas stream is sufficient for cauterising the horn bud without burning or singeing thereof. Accordingly, the horn growth stunting device is a particular humane device and allows stunting of the growth of a horn bud in a particularly humane manner.

The invention will be more clearly understood from the following description of a preferred embodiment thereof which is given by way of example only with reference to the accompanying drawings, in which:

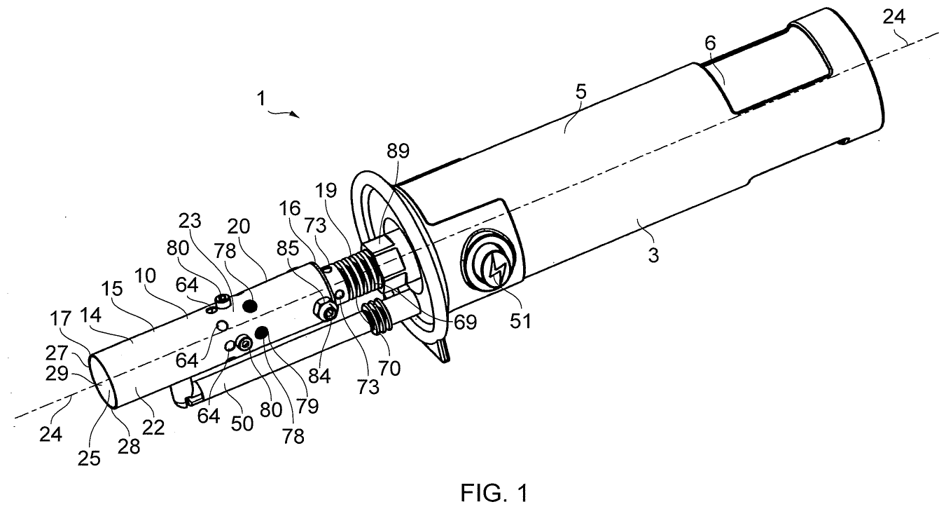

FIG. 1 is a perspective view of a gas powered horn growth stunting device according to the invention,

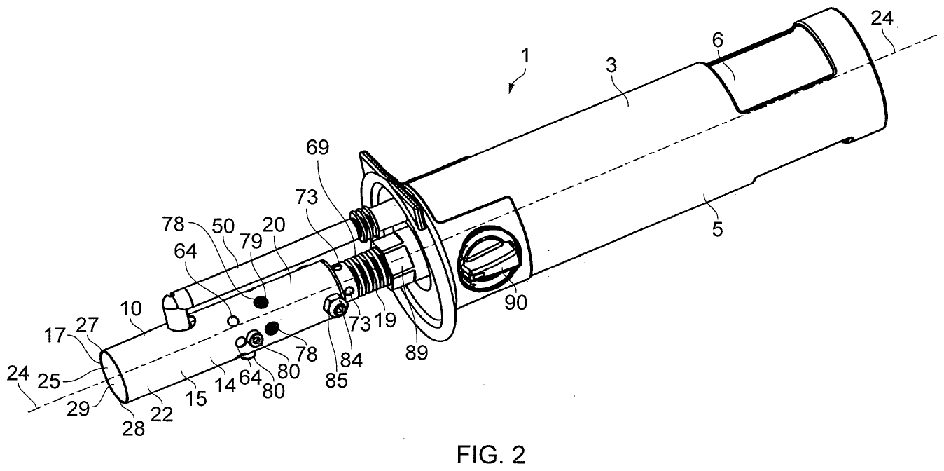

FIG. 2 is another perspective view of the horn growth stunting device of FIG. 1,

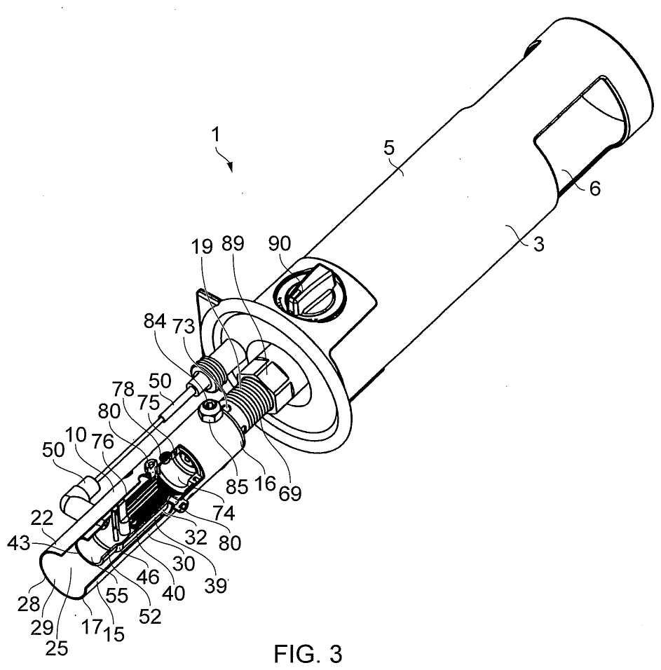

FIG. 3 is a partly cut-away perspective view of the horn growth stunting device of FIG. 1,

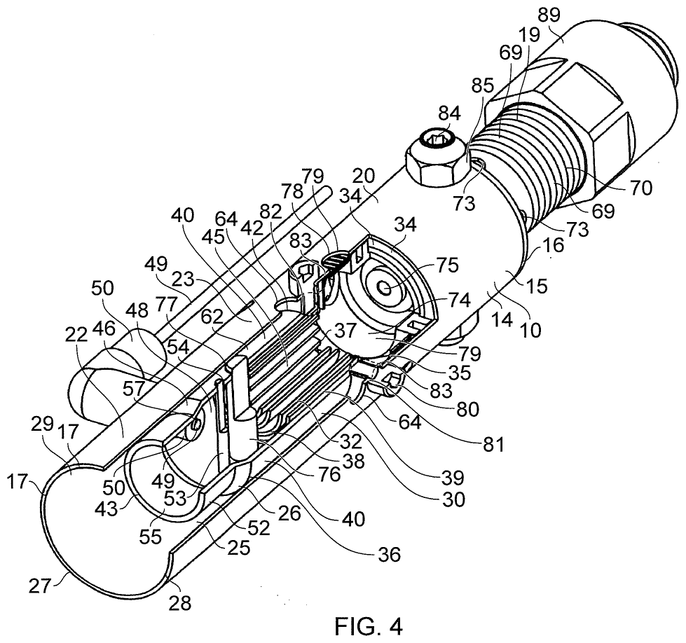

FIG. 4 is an enlarged partly cut-away perspective view of a portion of the horn growth stunting device of FIG. 1, in

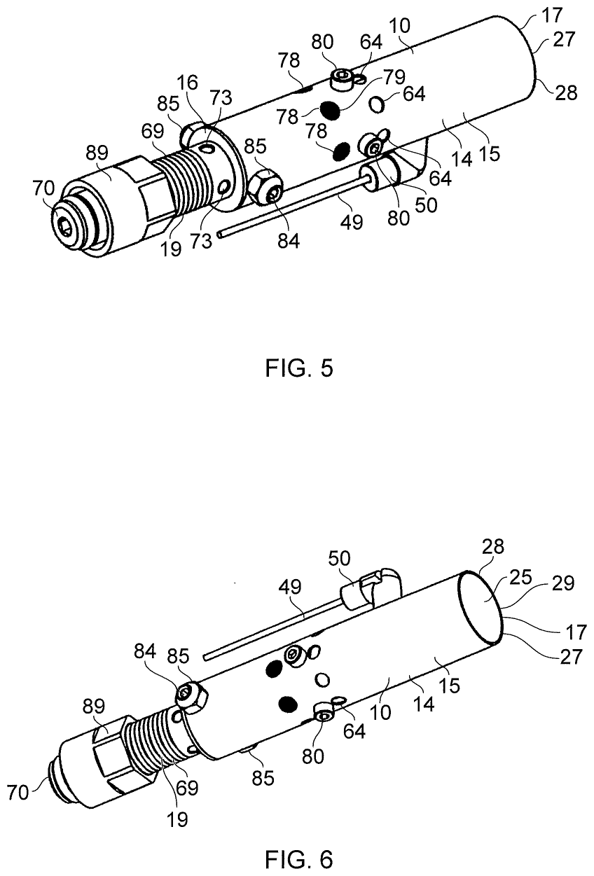

FIG. 5 is a perspective view of the portion of FIG. 4 of the horn growth stunting device of FIG. 1,

FIG. 6 is another perspective view of the portion of FIG. 4 of the horn growth stunting device of FIG. 1,

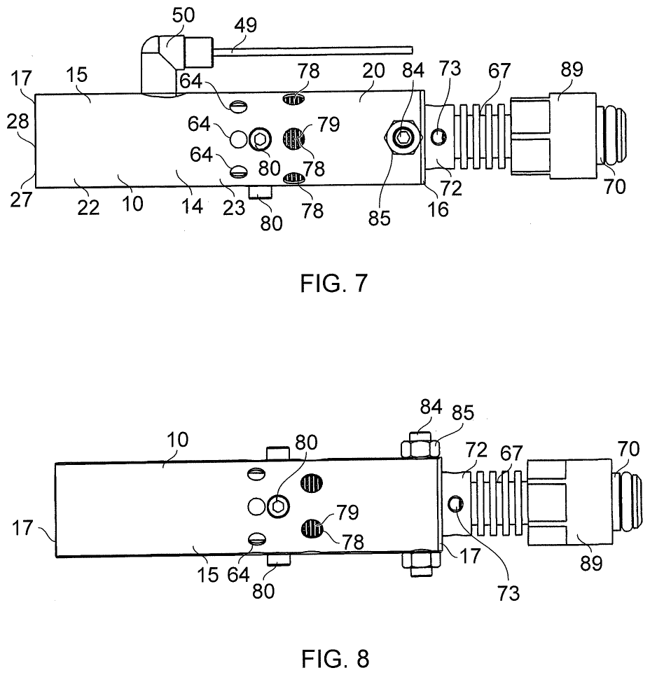

FIG. 7 is a side elevational view of the portion of FIG. 4 of the horn growth stunting device of FIG. 1,

FIG. 8 is a top plan view of the portion of FIG. 4 of the horn growth stunting device of FIG. 1,

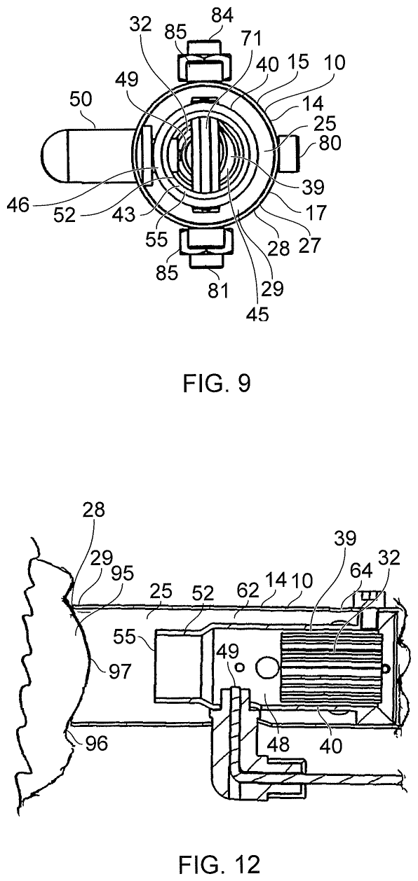

FIG. 9 is an end elevational view of the portion of FIG. 4 of the horn growth stunting device of FIG. 1,

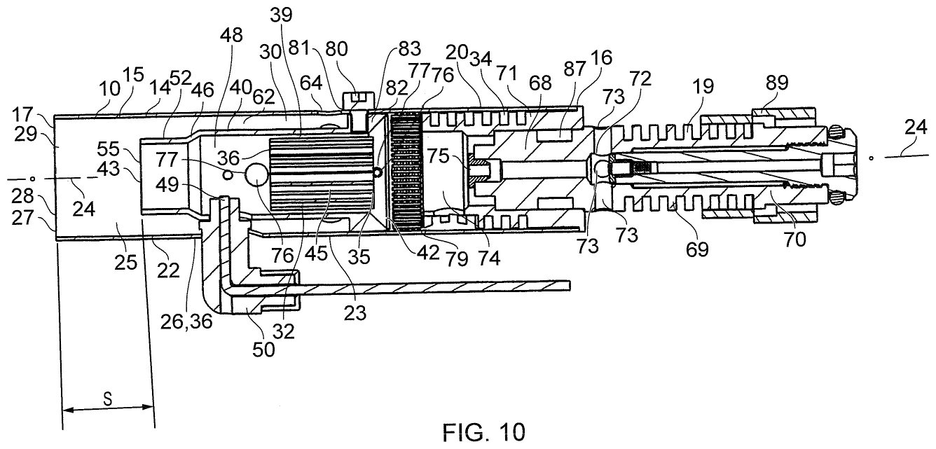

FIG. 10 is a cross-sectional side elevational view of the portion of FIG. 4 of the horn growth stunting device of FIG. 1,

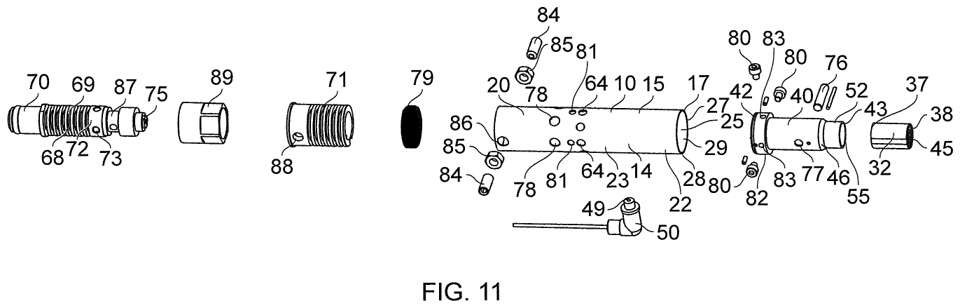

FIG. 11 is an exploded perspective view of the portion of FIG. 4 of the horn growth stunting device of FIG. 1, and

FIG. 12 is a cross-sectional side elevational view of a portion of the horn growth stunting device of FIG. 1 in use.

Referring to the drawings there is illustrated a gas-powered horn growth stunting device according to the invention indicated generally by the reference numeral 1, which in this embodiment of the invention is configured as a hand-held gas-powered horn growth stunting device, and is particularly suitable for stunting growth of horn buds 95 in young animals, such as, for example, calves, goats, sheep and the like. The horn growth stunting device 1 comprises a handle 3 comprising an elongated tubular sleeve 5 of circular transverse cross-section of a suitable material, which in this embodiment of the invention comprises stainless steel. The sleeve 5 defines a hollow interior region 6 also of circular transverse cross-section and a longitudinal central axis 7. A reservoir (not shown) is located in the hollow interior region 6 of the sleeve 5 for storing fuel gas, in this embodiment of the invention butane in liquid form. A pressure regulator (not shown) is located in the hollow interior region 6 of the sleeve 5 for reducing the pressure of the liquid gas from the reservoir to convert the gas from the liquid phase to the gaseous phase. A flow controller (also not shown) is located in the hollow interior region 6 of the sleeve 5 for regulating the flow of the fuel gas from the reservoir. An isolating valve (not shown) is located in the hollow interior region 6 of the sleeve 5 through which fuel gas is selectively supplied and controlled from the reservoir.

A main housing 10 of stainless steel comprising an elongated hollow cylinder 15 having a cylindrical wall 14 and extending between a proximal end 16 and a distal end 17 is connected at its proximal end 16 to the handle 3 by a connecting housing 19, through which fuel gas is delivered from the reservoir in the handle 3 to the main housing 10. The main housing 10 comprises a proximal portion 20, a distal portion 22 and a central portion 23 located between the proximal and distal portions 20 and 22. The main housing 10 defines a main longitudinal central axis 24 which coincides with the longitudinal central axis defined by the sleeve 5 of the handle 3.

The distal portion 22 of the main housing 10 defines a main chamber 25 extending from a proximal end 26 to a distal end 27 coinciding with the distal end 17 of the main housing 10. The distal end 17 of the main housing 10 defines a horn bud engaging distal rim 28 which in turn defines an open mouth 29 to the main chamber 25. The horn bud engaging distal rim 28 is configured to engage the horn bud 95 of an animal, the growth of which is to be stunted, adjacent an outer periphery 96 of the horn bud 95 with a central portion 97 of the horn bud 95 located in the open mouth 29 and possibly extending into the main chamber 25, see FIG. 12 as will be described below.

The central portion 23 of the main housing 10 defines a central chamber 30 which extends from a proximal end 35 to a distal end 36 adjacent the proximal end 26 of the main chamber 25. The central chamber 30 houses an elongated gas catalytic element 32 for converting fuel gas to heat, for in turn producing a hot gas stream, which is delivered into the main chamber 25 to impinge on the horn bud 95 of the animal for stunting the growth thereof. The proximal portion 20 of the main housing 10 defines a supply chamber 34 through which fuel gas is supplied to the gas catalytic element 32 in the central chamber 30 as will be described below.

An elongated tubular sub-housing 40 of circular transverse cross-section and of stainless steel is located in the central chamber 30 concentric with the main housing 10, and extends from the central chamber 30 into the main chamber 25. The sub-housing 40 extends from a proximal end 42 adjacent the proximal end 35 of the central chamber 30 to a distal end 43 located in the main chamber 25. A proximal portion of the sub-housing 40 defines a combustion chamber 39, within which the gas catalytic element 32 is housed concentrically with the sub-housing 40.

The gas catalytic element 32 extends from a proximal end 37 to a distal end 38. The proximal end 37 of the gas catalytic element 32 substantially coincides with the proximal end 42 of the sub-housing 40, and the distal end 38 of the gas catalytic element 32 defines the distal end of the combustion chamber 39. In this embodiment of the invention the gas catalytic element 32 comprises a platinum coated sheet of metal which is rolled about a central axis which coincides with the main central axis 24 of the main housing 10. The gas catalytic element 32 defines an elongated passageway 45 extending from the proximal end 37 to the distal end 38 thereof for accommodating the fuel gas from the proximal end 37 to the distal end 38. The rolling of the gas catalytic element 32 about the central axis thereof results in the gas catalytic element 32 defining the passageway 45 therethrough being of spiral shape transverse cross-section when the gas catalytic element 32 is viewed along its central axis. The gas catalytic element 32 is configured to produce the hot gas stream at a working temperature of approximately 450° C.

A portion of the sub-housing 40 extending distally from the combustion chamber 39 to a tapering section 46 defines a flame combustion chamber 48, within which the fuel gas having passed through the gas catalytic element 32 is initially burned with flame combustion. The initial burning of the fuel gas in flame combustion in the flame combustion chamber 48 results in the root portion of the flame adjacent the distal end 38 of the gas catalytic element 32 raising a portion of the gas catalytic element 32 adjacent the distal end 38 thereof to its ignition temperature. Once the portion of the gas catalytic element 32 adjacent the distal end 38 thereof reaches its ignition temperature, catalytic conversion of the fuel gas to heat is initiated. As the remainder of the gas catalytic element 32 progressively reaches the ignition temperature, catalytic conversion of the fuel gas spreads throughout the gas catalytic element 32. This in turn results in the flame in the flame combustion chamber 48 being starved of fuel gas, and thus the flame is extinguished. In general, the hot gas stream reaches the working temperature of approximately 450° C. approximately 60 seconds after the gas catalytic element 32 commences to convert the fuel gas to heat by catalytic conversion.

An electrode 49 extending along the exterior of the main housing 10 from the handle 3 through a tubular ceramic electrical insulating tube 50 terminates in the flame combustion chamber 48 for producing a spark to ignite the fuel gas to initially burn in the flame combustion chamber 48 in a flame. A piezo electric igniter element (not shown) is located in the handle 3 for producing a high voltage on the electrode 49 to generate the spark in the flame combustion chamber 48. The piezo electric igniter element is activated by a push button switch 51 in the handle 3. The operation of such a piezo electric igniter element for providing a high voltage to an electrode for generating a spark in a combustion chamber for igniting fuel gas to burn in a flame will be well known to those skilled in the art. A pin 53 in the flame combustion chamber 48 extending between and through holes 54 extending radially through the sub-housing at ground potential is spaced apart from the tip 57 of the electrode 49 to produce a spark gap within which a spark is produced to ignite the fuel gas to burn in a flame.

A distal portion of the sub-housing 40 extending between the tapered section 46 thereof and the distal end 43 thereof defines a means for directing the hot gas stream from the gas catalytic element 32 towards the open mouth 29 of the main chamber 25, namely, a nozzle 52. The nozzle 52 terminates in a nozzle outlet 55 defined by the distal end 43 of the sub-housing 40. The nozzle 52 communicates with the gas catalytic element 32 through the flame combustion chamber 48 for receiving the hot gas stream produced by the gas catalytic element 32 as it converts the fuel gas to heat. The nozzle 52 is configured in the main chamber 25 to direct the hot gas stream at the working temperature of 450° C. from the gas catalytic element 32 distally in the main chamber 25 towards the open mouth 29 in order to impinge the hot gas stream on the horn bud 95 of the animal when the distal rim 28 of the main housing 10 is engaged adjacent the outer periphery 96 of the horn bud 95 with a central portion 97 of the horn bud 95 located in the open mouth 29, and in general, extending into the main chamber 25. The distal end 43 of the sub-housing 40, which defines the nozzle outlet 55 of the nozzle 52, is located in the main chamber 25 spaced apart proximately from the distal rim 28 of the main housing 10 a distance s of approximately 15 mm, see FIG. 10, although in some embodiments of the invention the spacing s of the distal end 43 of the sub-housing 40 from the distal rim 28 of the main housing 10 may lie in the range of 5 mm to 40 mm.

The outer diameters of the sub-housing 40 from the proximal end 42 to the distal end 43 thereof are less than the inner diameter of the main housing 10, so that the sub-housing 40 defines with the main housing 10 an annular exhaust gas passageway 62 which extends from the main chamber 25 for accommodating gases of the hot gas stream, which are deflected from the horn bud 95 back into the main chamber 25, to a plurality of exhaust gas ports 64. The exhaust gas ports 64 extend through the cylindrical wall 14 of the main housing 10 and are spaced apart circumferentially around the main housing 10.

Returning now to the supply chamber 34 of the main housing 10, the supply chamber 34 houses a distal portion 68 of a delivery means, namely, a gas supply tube 69, a proximal portion 70 of which forms the connecting housing 19, and through which fuel gas is delivered from the reservoir (not shown) in the handle 3 to the gas catalytic element 32. A sleeve 71 extending around the distal portion 68 of the gas supply tube 69 is engageable in the supply chamber 34 of the main housing 10 for securing the main housing 10 to the gas supply pipe 69. The distal portion 68 of the gas supply tube 69 is retained in the supply chamber 34 by grub screws 84 which extend through nuts 85 welded onto the cylindrical wall 14 of the main housing 10, and in turn through corresponding bores 86 and 88 extending through the cylindrical wall 14 of the main housing 10 and the sleeve 71, respectively, to engage a corresponding annular recess 87 extending circumferentially around the gas supply tube 69. A gland nut 89 located on the gas supply tube 69 adjacent the proximal portion 70 thereof secures the connecting housing 19 to the handle 3. The gas supply tube 69 is connected to the isolating valve (not shown) in the handle 3, and in turn to the fuel gas reservoir (not shown) through the flow control valve and the pressure regulator (none of which are shown) in the handle 3.

The gas supply tube 69 defines a Venturi mixer 72 in which fuel gas passing through the gas supply tube 69 is mixed with air. Air inlet ports 73 extend through the gas supply tube 69 to the Venturi mixer 72 for accommodating air therethrough to the Venturi mixer 72. The gas supply tube 69 terminates in a gas delivery nozzle 75 through which the fuel gas/air mixture is delivered to the gas catalytic element 32 through an intermediate chamber 74 defined by a distal portion of the supply chamber 34. Further air inlet ports 78 extend through the cylindrical wall 14 of the main housing 10 for accommodating air into the intermediate chamber 74 in order to keep the temperature in the intermediate chamber 74 upstream of the gas catalytic element 32 relatively low to prevent combustion of the fuel gas/air mixture upstream of the gas catalytic element 32.

An annular flame retention mesh 79 extends around the inner periphery of the cylindrical wall 14 of the main housing 10 in the intermediate chamber 74 adjacent the air inlet ports 78 to act as a flame retention element for preventing any backfire of flame passing outwardly through the air inlet ports 78.

A proximal flange 82 extending around the proximal end 42 of the sub-housing 40 is engageable with the inner surface of the wall 14 of the main housing 10 for retaining the sub-housing 40 concentric with and in the main housing 10. Grub screws 80 which extend through corresponding radial bores 81 in the cylindrical wall 14 of the main housing 10, and in turn into radial bores 83 extending through the proximal flange 82 retain the sub-housing 40 in position in the main housing 10. Retaining means comprising pins 76 located in the sub-housing 40 and extending between and through openings 77 in the sub-housing 40 adjacent the proximal and distal ends 37 and 38 of the gas catalytic element 32 locate and retain the gas catalytic element 32 in the combustion chamber 39.

A control switch 90 in the handle 3, is mechanically coupled to the isolating valve (not shown) in the handle 3, which also acts as a flow control switch, for controlling the supply of fuel gas to the gas catalytic element 32.

In use, with the main housing 10 connected to the handle 3 through the connecting housing 19 by the gland nut 89, and with the fuel gas reservoir (not shown) in the handle 3 charged with liquid butane, the horn growth stunting device 1 is ready for use. The isolating valve (not shown) in the handle 3 is operated by the control switch 90 in the handle 3 for supplying fuel gas to the Venturi mixer 72 where it is mixed with air, and the fuel gas/air mixture is in turn delivered through the gas delivery nozzle 75 to the combustion chamber 30. Initially, until the gas catalytic element is raised to its ignition temperature, the fuel gas/air mixture passes through the gas catalytic element 32 into the flame combustion chamber 48. The push button switch 51 in the handle 3 is depressed to operate the piezo electric igniter (not shown) to generate a spark in the flame combustion chamber 48 between the tip 57 of the electrode 49 and the pin 53, which ignites the fuel gas/air mixture to burn in a flame in the flame combustion chamber 48. The heat from the root of the flame raises the temperature of the portion of the gas catalytic element 32 adjacent the distal end 38 thereof to its ignition temperature, which then commences to convert the fuel gas/air mixture to heat. Heat rapidly conducts through the gas catalytic element 32, which in turn results in the fuel gas/air mixture being converted to heat by the gas catalytic element 32. This in turn starves the flame in the flame combustion chamber 48 of gas, which in turn is extinguished.

The conversion of the fuel gas to heat by the gas catalytic element 32 results in the hot gas stream being urged from the gas catalytic element 32 through the nozzle 52, and the nozzle outlet 55 directs the hot gas stream at the working temperature of approximately 450° C. to the open mouth 29 of the main chamber 25.

With the horn growth stunting device 1 operating in this manner, the distal rim 28 defined by the main housing 10 is brought into engagement with the horn bud 95, the growth of which is to be stunted, with the distal rim 28 extending around and adjacent the periphery 96 of the horn bud, see FIG. 12. With the central portion 97 of the horn bud 95 located in the open mouth 29, and in general, extending through the open mouth 29 into the main chamber 25, the hot gas stream at the working temperature of approximately 450° C. impinges directly onto the portion of the horn bud 95 in the open mouth 29. The hot gas stream impinging on the horn bud 95 results in cauterising of the horn bud 95, thereby stunting the growth thereof. The hot gas stream deflected from the horn bud 95 is returned from the main chamber 25 through the exhaust gas passageway 62, and in turn through the exhaust gas ports 64. Typically, the central portion 97 of the horn bud 95 extends into the main chamber 25 when the distal rim 28 of the main chamber 25 is in engagement with the periphery 96 of the horn bud 95, a distance so that the spacing between the central portion 97 of the horn bud 95 and the nozzle outlet 55 of the nozzle 52 is approximately 3 mm to 5 mm.

On completion of cauterising of the horn bud 95, the distal rim 28 of the horn growth stunting device 1 is removed from the horn bud 95. The distal rim 28 of the main housing 10 is then applied in a similar manner to the other horn bud 95 of the animal for similarly cauterising thereof.

While the sub-housing has been described as defining a flame combustion chamber located between the gas catalytic element and the nozzle 52, in some embodiments of the invention it is envisaged that the flame combustion chamber may be omitted, or the flame combustion chamber may be located at the proximal end of the gas catalytic element 32. In cases where the flame combustion chamber has been entirely omitted, it is envisaged that one of the exhaust gas ports 64 may be configured to communicate directly with the gas catalytic element 32. In which case, some of the fuel gas being delivered into the gas catalytic element initially would pass through that exhaust gas port, and could be ignited to burn in flame combustion with the root of the flame located adjacent that exhaust gas port, which in turn would commence to raise the temperature of an adjacent portion of the gas catalytic element to its ignition temperature.

It will also be appreciated that while the main housing 10 has been described as defining the main chamber, the central chamber and the gas supply chamber, while this is advantageous, it is not essential. In some embodiments of the invention the main chamber, the central chamber and the gas supply chamber may be provided by different and suitable housings. Indeed, in some embodiments of the invention it is envisaged that the gas supply chamber may be incorporated into the handle.

While the means for directing the hot gas stream from the gas catalytic element to the open mouth of the main chamber has been described as comprising a nozzle, any other means for directing the hot gas stream to the open mouth may be provided, and in some embodiments of the invention it is envisaged that the nozzle may be omitted, and the combustion chamber would be adapted to direct the hot gas stream directly to the open mouth of the main chamber.

It will be appreciated that while the horn growth stunting device has been described for stunting the growth of a horn bud of a calf, the device may be used for stunting the growth of the horn buds of any animal, for example, the horn buds of sheep, goats or any other animal in which it is desired to inhibit the growth of horns thereon.

While the materials of the components of the horn growth stunting device have been described as being of specific materials, the components of the horn growth stunting device may be of any other suitable material. However, since the horn growth stunting device is to be used in connection with animals, it is desirable that at least the main housing should be of stainless steel.

While the handle and the main housing of the device have been described as being of cylindrical shape, the handle and the main housing may be of any other desired or suitable shape.

Additionally, while the horn growth stunting device has been described as comprising a reservoir in the handle for storing the fuel gas in liquid form, in some embodiments of the invention it is envisaged that the reservoir may be omitted, and the horn growth stunting device would be adapted for releasably connecting to a suitable fuel gas source, which would typically be in liquid form. In which case, the horn growth stunting device would typically be adapted for coupling to such a suitable source of fuel gas by a flexible gas supply tube.

While the fuel gas has been described as being butane, it will be readily apparent to those skilled in the art that any other suitable fuel gas may be used.

1-73. (canceled)

74. A horn growth stunting device comprising a main housing defining a main chamber and terminating in a horn bud engaging distal rim defining an open mouth to the main chamber, a gas catalytic element for converting fuel gas to heat and being configured to generate a hot gas stream, a means configured to direct the hot gas stream from the gas catalytic element into the main chamber and towards the open mouth thereof, so that when the horn bud engaging distal rim of the main housing is engaged with a horn bud of an animal, the hot gas stream is directed onto a portion of the horn bud in the open mouth.

75. A horn growth stunting device as claimed in claim 74 in which the main chamber extends from a proximal end to a distal end terminating in the horn bud engaging distal rim defining the open mouth to the main chamber.

76. A horn growth stunting device as claimed in claim 74 in which the main housing comprises a tubular housing, and preferably, the main housing defines a longitudinally extending main central axis, and advantageously, the main chamber is concentric with the main central axis defined by the main housing, and preferably, an exhaust gas passageway extends in a proximal direction from the main chamber for accommodating exhaust gases from the main chamber deflected from the horn bud to at least one exhaust port, and preferably, the exhaust gas passageway comprises an annular exhaust gas passageway.

77. A horn growth stunting device as claimed in claim 74 in which the means to direct the hot gas stream towards the open mouth of the main chamber comprises a nozzle communicating with the gas catalytic element for directing the hot gas stream to the open mouth of the main chamber, and preferably,
the nozzle terminates in a distal nozzle outlet adapted to direct the hot gas stream to the open mouth of the main chamber, and advantageously, the nozzle extends into the main chamber with the nozzle outlet directed towards and spaced apart proximally from the open mouth defined by the horn bud engaging distal rim of the main housing, and preferably, the nozzle outlet is spaced apart proximally from the open mouth defined by the horn bud engaging distal rim a distance in the range of 5 mm to 40 mm, and
advantageously, the nozzle outlet is spaced apart proximally from the open mouth defined by the horn bud engaging distal rim a distance in the range of 10 mm to 20 mm,
and preferably, the nozzle outlet is spaced apart proximally from the open mouth defined by the horn bud engaging distal rim a distance of approximately 15 mm.

78. A horn growth stunting device as claimed in claim 77 in which at least a portion of the exhaust gas passageway is defined between the nozzle and a portion of the main housing defining the main chamber, and preferably, the exhaust gas passageway extends around the nozzle, and advantageously, the nozzle is concentric with the main central axis defined by the main housing.

79. A horn growth stunting device as claimed in claim 74 in which the gas catalytic element is located in the main housing, and preferably, the gas catalytic element is concentric with the main central axis defined by the main housing, and advantageously, the gas catalytic element comprises an elongated element extending from a proximal end to a distal end, and preferably, the nozzle communicates with the distal end of the gas catalytic element.

80. A horn growth stunting device as claimed in claim 74 in which the gas catalytic element is located in a combustion chamber located in the main housing proximal of the main chamber, and preferably, the combustion chamber is located in a sub-housing, and advantageously, the sub-housing is located in the main chamber, and preferably, the sub-housing comprises an elongated tubular housing, and advantageously, the sub-housing is of circular transverse cross-section, and preferably, the sub-housing is concentric with the main central axis defined by the main housing, and advantageously, the sub-housing is open at its respective opposite ends.

81. A horn growth stunting device as claimed in claim 80 in which the sub-housing defines with a portion of the main housing, the exhaust gas passageway, and preferably, the sub-housing defines with the portion of the main housing the exhaust gas passageway as an annular exhaust gas passageway, and advantageously, the exhaust gas passageway defined between the sub-housing and the main housing defining the combustion chamber extends around the sub-housing, and preferably, the exhaust gas passageway defined between the sub-housing and the main housing terminates in the at least one exhaust gas port extending through the main housing.

82. A horn growth stunting device as claimed in claim 74 in which a flame combustion chamber is located in the main housing for accommodating flame combustion of fuel gas therein for raising the temperature of the gas catalytic element to its ignition temperature, and preferably, the flame combustion chamber is located between the gas catalytic element and the horn bud engaging distal rim of the main chamber, and advantageously, the main chamber communicates with the gas catalytic element through the flame combustion chamber, and preferably, an electrode extends into the flame combustion chamber for igniting fuel gas to burn in a flame therein, and advantageously, the nozzle communicates with the gas catalytic element through the flame combustion chamber.

83. A horn growth stunting device as claimed in claim 74 in which a delivery means is provided for delivering fuel gas to the gas catalytic element, and preferably, the delivery means is configured for delivering the fuel gas to the gas catalytic element adjacent the proximal end thereof, and advantageously, the delivery means is located proximal of the gas catalytic element, and preferably, the delivery means is located in the main housing, and advantageously, the delivery means comprises a Venturi mixer for mixing air with the fuel gas for delivery to the gas catalytic element.

84. A horn growth stunting device as claimed in claim 74 in which a handle is provided extending from the main housing, and preferably, the handle defines a fuel gas reservoir for storing fuel gas in liquid form for supply to the delivery means, and advantageously, the handle comprises a tubular handle, and preferably, the handle is of circular transverse cross-section, and advantageously, the handle defines a central handle axis, and preferably, the central axis defined by the handle coincides with the main central axis defined by the main housing.

85. A horn growth stunting device as claimed in claim 74 in which the horn growth stunting device is configured as a portable device, and preferably, the horn growth stunting device is configured as a hand-held portable device.

86. A horn growth stunting device as claimed in claim 74 in which the gas catalytic element is configured to produce the hot gas stream at a working temperature in the range of 300° C. to 600° C., and preferably, the gas catalytic element is configured to produce the hot gas stream at a working temperature in the range of 350°° C. to 550°° C., and advantageously, the gas catalytic element is configured to produce the hot gas stream at a working temperature in the range of 450° C. to 500° C., and preferably, the gas catalytic element is configured to produce the hot gas stream at a working temperature of approximately 450° C.

87. A horn growth stunting device as claimed in claim 86 in which the gas catalytic element is configured to produce the hot gas stream at the working temperature within a time period from ignition thereof in the range of 30 seconds to 120 seconds, and preferably, the gas catalytic element is configured to produce the hot gas stream at the working temperature within a time period from ignition thereof in the range of 45 seconds to 90 seconds, and advantageously, the gas catalytic element is configured to produce the hot gas stream at the working temperature within a time period from ignition thereof for approximately 60 seconds.

88. A horn growth stunting device as claimed in claim 74 in which the main housing is of circular transverse cross-section, and preferably, a plurality of exhaust gas ports are located at circumferentially spaced apart intervals around and extending through the main housing, and preferably, the horn growth stunting device is adapted for stunting growth of a horn bud of a calf.

89. A method for stunting the growth of a horn bud of an animal, the method comprising directing a hot gas stream through a nozzle from a gas catalytic element to a horn bud of the animal, the growth of which is to be stunted.

90. A method as claimed in claim 89 in which a nozzle outlet of the nozzle is spaced apart in use from the horn bud, and preferably, the nozzle outlet of the nozzle is spaced apart in use from the horn bud a distance in the range of 3 mm to 40 mm, and advantageously, the nozzle outlet of the nozzle is spaced apart in use from the horn bud a distance in the range of 3 mm to 15 mm, and preferably, the nozzle outlet of the nozzle is spaced apart in use from the horn bud a distance in the range of 3 mm to 10 mm, and advantageously, the nozzle outlet of the nozzle is spaced apart in use from the horn bud a distance in the range of 3 mm to 7 mm, and preferably, the nozzle outlet of the nozzle is spaced apart in use from the horn bud a distance of approximately 5 mm.

91. A method as claimed in claim 89 in which the gas catalytic element produces the hot gas stream at a working temperature in the range of 300° C. to 600° C., and preferably, the gas catalytic element produces the hot gas stream at a working temperature in the range of 350° C. to 550° C., and advantageously, the gas catalytic element produces the hot gas stream at a working temperature in the range of 450° C. to 500° C., and preferably, the gas catalytic element produces the hot gas stream at a working temperature of approximately 450°° C.

92. A method for stunting the growth of a horn bud of an animal comprising directing a hot gas stream at the horn bud, the hot gas stream being derived from a horn growth stunting device as claimed in claim 74.

93. A method as claimed in claim 92 in which the horn bud engaging distal rim of the main housing of the horn growth stunting device is engaged with the horn bud adjacent an outer periphery thereof, with a substantially central portion of the horn bud located in the open mouth to the main chamber, and preferably, the hot gases are directed to the horn bud from the nozzle to impinge thereon.
